(19) United States
(12) Patent Application Publication
(10) Pub. No.: US 2010/0207839 A1
(43) Pub. Date: Aug. 19, 2010

(54) Method for Producing a Transmission Module and Transmission Module

(76) Inventors: Manfred Rietzler, Marktoberdorf (DE); Karl-Heinz Wendisch, Salzkotten (DE)

Correspondence Address: QUARLES & BRADY LLP, 411 E. WISCONSIN AVENUE, SUITE 2040, MILWAUKEE, WI, 53202-4497, US

(21) Appl. No.: 12/682,755

(22) PCT Filed: Jul. 30, 2008
(86) PCT No.: PCT/EP2008/006262

§ 371 Date: Apr. 12, 2010

(30) Foreign Application Priority Data
Oct. 16, 2007 (DE) 10 2007 050 102.3

(51) Int. Cl. H01Q 1/36; H01P 11/00

(52) U.S. Cl. 343/895; 29/600

(57) ABSTRACT

The invention relates to a method for producing a transmission module (24) having a transmission element disposed on an insulating substrate (10), the transmission element comprising a conductor arrangement (13) disposed at least partially in a helical fashion and having at least two chip terminal faces (17, 18) and two conductor ends (20, 22), wherein an antenna device (11) is formed by producing a connecting bridge between connecting regions of the conductor ends (20, 22), said connecting bridge (23) being guided across conductor regions in an insulated manner, wherein, after the application of a viscous connecting bridge material to the conductor ends, an indentation is formed in a contact surface of the conductor ends such that the connecting bridge material subsequently fills the indentation thusly formed at least in regions.

The present invention relates to a method for producing a transmission module according to the preamble of claim 1. Furthermore, the present invention relates to a transmission module for producing a transponder module according to the preamble of claim 2 as well as to a transponder module having such a transmission module.

Transmission modules of the above-mentioned type are utilized for producing transponders containing characteristic data stored on chips that serve for identifying objects tagged with such transponders. Thereby, the transmission modules regularly execute primarily an antenna function that allows contactless access to the characteristic data and reading of said characteristic data with the aid of a suitable reading device. For producing such transmission modules two fundamentally different technologies have become established, the first technology being the so-called wire laying technology, in which a wire conductor provided for the formation of an antenna device is disposed on a substrate using a wire laying technique, and the second technology used for producing antenna devices being the etching technique known as such from Printed Circuit Board (PCB) technology, in which in a combination of a deposition and an etching technique a conductor pattern is formed on the surface of an insulating substrate. Due to their small thickness dimensions transmission modules produced using an etching technique are particularly suitable for the production of film-like electronic labels that can be attached to an object to be identified using adhesive bonding.

Due to the essentially helically-shaped design of the conductor pattern for realizing the antenna function, it is necessary to form bridging regions that make it possible to establish an electrical connection of the conductor ends of the antenna device with each other or else with the chip in order to allow contacting of the antenna device with a chip. Unlike the wire laying technique, in which the utilization of an insulating wire conductor makes it possible to form bridging regions in situ, i.e. during the wire laying procedure simultaneously with the formation of the antenna device, the production of the antenna device using a deposition/etching technique requires the subsequent creation of a connecting bridge after the formation of an insulating intermediate layer on the conductor regions being bridged by the connecting bridge. Alternatively, it is also possible to form via-connections in order to be able to utilize the insulating carrier substrate per se as an insulating intermediate layer and to form the connecting bridge on the substrate surface opposite the conductor regions.

In practice, it has turned out that a connection between the connecting bridge and the corresponding conductor ends of the antenna device that is reliable as well as resistant even to mechanical bending stresses is not readily realizable. According to the prior art, the connecting bridges formed between the conductor ends of the antenna device are formed as a metallization, similarly as in the case of the antenna device per se, i.e. using a deposition technique, or else likewise by imprinting a conductive paste. The retention forces thereby created merely in the form of surface forces in the connecting regions between the connecting bridge and the corresponding conductor ends are accordingly small such that dynamical alternating bending stresses occurring in particular during the utilization of the labels may give rise to undesirable delamination between the connecting bridge and the conductor ends of the antenna device, and may hence accordingly lead to component failure.

For this reason, it is an object of the present invention to propose a method for producing a transmission module as well as a transmission module, the inventive method making it possible to produce a transmission module which is also capable of withstanding alternating bending stresses.

This object is achieved by a method having the features of claim 1 and a transmission module having the features of claim 2.

In the inventive method, an oxide layer formed on the conductor ends is fractured due to the formation of an indentation in a contact surface of the conductor ends such that directly after the destruction of the oxide layer at least in situ, a contact is established between the connecting bridge material which subsequently flows into the formed indentation and the contact material of the conductor ends which is frequently formed of aluminum. As a function of the composition of the connecting bridge material, for instance in the case of a connecting bridge material formed as soldering paste, a permanent connection can be established using a reflow method. In this context, the indentation may be formed merely in the surface by fracturing the oxide layer or may likewise extend into the material of the conductor ends. Such indentations may be formed for instance by abrasive brushing acting merely on the surface, or else by an embossing process that allows to penetrate deeper into the surface.

Hence, the inventive method makes it possible to establish a reliable mechanical and electrical contact without interposed oxide layers.

In the inventive transmission module, in order to form the connecting regions between the conductor ends of the conductor arrangement and the contact ends of the connecting bridge, interlocking connections are created which may be formed either on the surface or else at a larger depth.

Designing the connecting regions as interlocking connections in contrast to essentially evenly formed connecting regions between contact material layers allows for designing the connecting regions in a spatial fashion, said spatial design being much more suitable for absorbing connection forces acting transversally to the substrate plane without the risk of delamination.

It has proved to be especially advantageous if the connection is additionally realized as a thermal connection, in which the connecting regions are formed due to the interaction between pressure and temperature.

If the connection between the conductor ends and the contact ends is realized as an adhesive connection, the material for forming the connecting bridge can also be selected exclusively as a function of the conductive capacity thereof irrespective of other material properties thereof.

Forming the connecting bridge of a noble metal or an alloy containing a noble metal has proven especially reliable and corrosion-resistant in particular with respect to the combination with a conductor arrangement made of aluminum or an alloy containing aluminum.

The interlocking connection, which has been described above as being particularly reliable, between the conductor ends of the conductor arrangement and the contact ends of the connecting bridge can be rendered even more resistant vis-à-vis alternating stresses if the connecting bridge exhibits embossing zones having displacement funnels that are formed in the contact ends and that are formed so as to be tapered towards the conductor ends. By means of this aspect, in those regions of the connecting structure which are subjected to extreme stresses when stress is exerted between the contact ends of the connecting bridge and the conductor ends of the conductor arrangement, a structural arrangement exhibiting an exceptionally high degree of compression is obtained.

A particularly advantageous relation between the deformation force required for producing the structural arrangement and the compression of the structural arrangement can be obtained if the displacement funnels are formed in a conical shape. Thereby, the conical design facilitates in particular the penetration of a displacement body into the connecting region.

The displacement funnel may be formed in the shape of a pyramid such that some kind of rotational engagement can also be created in the connecting region, which makes it even possible to absorb load moments around an axis being vertically disposed in the connecting region.

Independently of the formation of the embossing zones and the displacement funnels it is advantageous if the same extend into the conductor ends in order to make it possible to obtain a specific degree of interlocking between the contact ends of the connecting bridge and the conductor ends of the antenna device.

If the connecting regions respectively exhibit a plurality of adjacently arranged interlocking connections, the interaction between the interlocking connections in the connecting regions can be advantageously used.

The inventive transponder module comprises a transmission module according to any one of the preceding claims, wherein the chip terminal faces of the antenna device are disposed so as to overlap with corresponding terminal faces of the chip, and wherein the chip is disposed on the substrate surface that has the antenna device disposed thereon.

A transponder module designed in line with the present invention is characterized by an especially small thickness in addition to a high degree of mechanical resistance, since both the antenna device and the chip are disposed on the same substrate surface. Due to the small thickness of the transponder module, surface tensions that occur due to bending stresses and that are exerted especially on the contact regions can also be reduced, unlike with transponder modules that are designed with a greater thickness. Moreover, such a transponder module can be produced in a particularly simple manner, since all production, assembly or contacting steps are performed on one and the same substrate surface so that no steps are required for subjecting the substrate to a turning procedure.

In the following, a preferred embodiment of a transponder module having a transmission module will be described in more detail with reference to the drawings.

In the drawings:

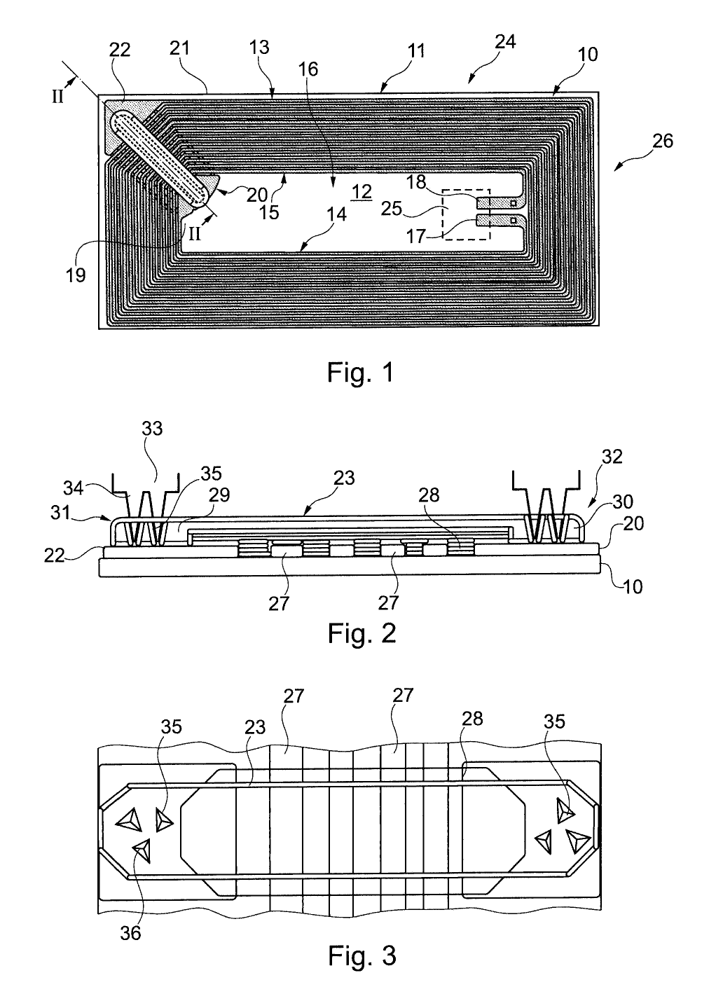

FIG. 1 is a plan view of a transponder module comprising an antenna device disposed on a substrate with a chip;

FIG. 2 is an enlarged sectional view of a connecting bridge depicted in FIG. 1 in a plan view according to sectional line II-II;

FIG. 3 is a plan view of the connecting bridge depicted in FIG. 2.

FIG. 1 illustrates an antenna device 11 disposed on a substrate 10 formed of an insulating material, for instance PVC, PET, PEN or polyimide. The antenna device 11 in the case at hand is composed of a conductor arrangement 13 formed on the substrate surface 12 in a manner known per se using an etching method, the conductor arrangement 13 having an inner conductor 14 and an outer conductor 15, each being formed at the ends thereof that are disposed in a central region 16 of the substrate surface 12 in the form of chip terminal faces 17, 18.

In the embodiment at hand, the inner conductor 14 is essentially formed in a U shape and has an inner conductor end 20 formed at an outer edge 19 of the central region 16. The outer conductor 15 extends from the second chip terminal face 18 in a helically-shaped arrangement up to a to substrate outer edge 21 and terminates there in an outer conductor end 22. For forming the antenna device 11, the inner conductor 14 and the outer conductor 15 of the conductor arrangement 13 are connected to one another at their conductor ends 20 and 22 via a connecting bridge 23 in an electrically conductive fashion. The antenna device 11 formed in this manner together with the substrate 10 creates a transmission module 24 which forms a transponder module 26 by way of contacting the chip terminal faces 17, 18 with a chip 25 being illustrated in FIG. 1 by a dash-dotted line.

As shown in FIG. 2, the connecting bridge 23 bridges conductor regions 27 of the outer conductor 15 disposed between the inner conductor end 20 and the outer conductor end 22 on the substrate surface 12, wherein an insulating intermediate layer 28 is disposed between the connecting bridge 23 and the conductor regions 27. The connecting bridge 23 formed in the present case of an alloy primarily consisting of silver is connected via its contact ends 29, 30 to the respective conductor ends 20, 22 of the conductor arrangement 13 being in the present case formed of a conductor material primarily containing aluminum while forming connecting regions 31, 32.

The electrically conductive connection between the contact ends 29, 30 of the connecting bridge 23 and the conductor ends 20, 22 of the conductor arrangement 13 can be produced in a first method step using a reflow process, i.e. by melting the connecting bridge material being applied to form the connecting bridge 23.

Subsequently, as illustrated in FIG. 2, for instance by an embossing or stamping tool acting upon the contact surface of the conductor ends 20, 22, an oxide layer formed on the conductor ends 20, 22 is fractured such that more or less clear-cut displacement funnels 35 are formed in the connecting regions 31, 32 due to tool tips 34 penetrating into the contact surface of the conductor ends 20, 22.

After removal of the tool tips 34 from the displacement funnels 35, the molten connecting bridge material flows into the displacement funnels 35, thusly forming with the same, subsequent to solidification and curing, an interlocking connection which is capable of withstanding mechanical stresses without the risk of a new oxide layer being meanwhile formed on the contact surfaces of the conductor ends 20, 22

As is apparent from FIG. 3, the displacement funnels 35 in the case of the present exemplary embodiment are formed in a pyramidal shape such that pyramidal edges 36 formed in the displacement funnel 35 contribute to the formation of additional displacement tips that provide for additional rotational engagement in the connecting plane.

1. Method for producing a transmission module having a transmission element disposed on an insulating substrate, the transmission element comprising a conductor arrangement disposed at least partially in a helical fashion and having at least two chip terminal faces and two conductor ends, wherein an antenna device is formed by producing a connecting bridge between connecting regions of the conductor ends, said connecting bridge being guided across conductor regions in an insulated manner, said method comprising:
applying a viscous connecting bridge material to the conductor ends; and then
forming an indentation in a contact surface of the conductor ends such that the connecting bridge material subsequently fills the indentation thusly formed at least in regions.

2. Transmission module for producing a transponder module, wherein the transmission module comprises an insulating substrate and a transmission element being disposed on the substrate and having a conductor arrangement disposed at least partially in a helical fashion and having two conductor ends for forming an antenna device provided with chip terminal faces, said conductor ends being electrically connected to one another in connecting regions by means of a connecting bridge being guided across conductor regions in an insulated manner, wherein the connecting regions exhibit interlocking connections between the conductor ends of the conductor arrangement and contact ends of the connecting bridge.

3. Transmission module according to claim 2, in which the interlocking connections are formed by filling indentations formed in the conductor ends.

4. Transmission module according to claim 2, in which the connection between the conductor ends and contact ends is a thermal connection.

5. Transmission module according to claim 2, in which the connection between the conductor ends and contact ends is an adhesive connection.

6. Transmission module according to claim 2, in which the conductor arrangement is formed of aluminum or an alloy containing aluminum and the connecting bridge is formed of a noble metal or of an alloy containing a noble metal.

7. Transmission module according to claim 2, in which the interlocking connection between the conductor ends of the conductor arrangement and the contact ends of the connecting bridge features embossing zones having displacement funnels that are formed in the contact ends and that are formed so as to be tapered towards the conductor ends.

8. Transmission module according to claim 7, in which the displacement funnels have a conical shape.

9. Transmission module according to claim 7, in which the displacement funnels are formed in the shape of a pyramid.

10. Transmission module according to claim 7, in which the displacement funnels extend into the conductor ends.

11. Transmission module according to claim 7, in which the connecting regions respectively feature a plurality of adjacently arranged positive-fit connections.

12. Transponder module comprising a transmission module according to claim 2, in which the chip terminal faces of the antenna device are arranged so as to overlap with corresponding contact surfaces of the chip and the chip is disposed on the substrate surface that has the antenna device disposed thereon.
